(19) United States
(12) Patent Application Publication
(10) Pub. No.: US 2010/0030644 A1
(43) Pub. Date: Feb. 4, 2010

(54) TARGETED ADVERTISING BY PAYMENT PROCESSOR HISTORY OF CASHLESS ACQUIRED MERCHANT TRANSACTIONS ON ISSUED CONSUMER ACCOUNT

(76) Inventor: Rajasekaran Dhamodharan, Redwood City, CA (US)

Correspondence Address: Quarles & Brady LLP, TWO NORTH CENTRAL AVENUE, One Renaissance Square, PHOENIX, AZ, 85004-2391, US

(21) Appl. No.: 12/185,332

(22) Filed: Aug. 4, 2008

(51) Int. Cl. G06Q 30/00; G06F 17/30

(52) U.S. Cl. 705/14.49; 705/10

(57) ABSTRACT

Content and targeted advertisements are simultaneously provided to a client. Upon receiving a request for content from the client, a content provider requests a targeted advertisement from a transaction processor. The targeted advertisement is derived using a spending profile based upon a history of cashless acquired merchant transactions made by a consumer on an account, where the account has been associated with the consumer by the content provider. The targeted advertisement is selected from an advertisement database and is likely to attract the consumer's attention, resulting in a purchase being made on the account. Once the targeted advertisement is selected, it is received by the content provider and fitted to the dimensions of the advertising space. A page containing the targeted advertisement and requested content is delivered to the client where it is displayed on a display device and viewed by the consumer.

### BACKGROUND

The present invention relates generally to targeted advertising, and more particularly to real time marketing of goods and services using behavioral targeted advertising techniques.

In the most basic terms, online marketing is the marketing of products and services over the Internet as opposed to more traditional market channels, such as department stores and catalogs. The unique aspects of the Internet allows vendors to distribute information about their products and services quickly and cheaply to consumers on a global basis, removing the inherent structural costs and limitations associated with brick-and-mortar stores. This factor has made online marketing essential for the survival of many business.

Companies, whether marketing online or through traditional channels, are faced with the challenges of ever increasing numbers of competitors, varying consumer preference, and the limited attention of consumers already inundated by advertisements. Having limited advertising budgets, it is imperative to a company's success to employ marketing strategies which realize the greatest return on investments by efficiently target potential consumers. Marketing strategies often employ predictive analytics and models to identify consumers most likely to respond to particular marketing offers. Targeting only these consumers increases a given investment's response rate thereby reducing the cost per acquisition.

One technique often used in online marketing is behavioral targeted advertisements. Behavioral targeting is the use of information collected on an individual's web-browsing behavior, such as the pages they have visited or the searches they have made, to select and display advertisements likely to elicit a response by the individual.

Examples of currently behavioral targeted advertisement systems include nugg.ad, DoubleClick, Netmining, and WunderLoop. Such systems can be “self-learning onsite behavioral targeting systems” meaning they monitor visitor response to a specific website's content and use this data to determine what is most likely to generate the desired action by the visitor. This method, however, is problematic in that a high level of traffic to a website is required before the probability of a particular offer eliciting the desired reaction can be determined with statistical confidence. Additionally, such systems cannot target the spending behavior of individual visitors, rather it focuses on the general behavior of the population which visits the website.

Existing methods of collecting information on individual consumers have their own limitations. Adware and spyware are types of programs that can monitor browsing activity on an individual basis and collect personal information for a third party. Adware is generally integrated into or bundled with other programs and, after installation, it displays, downloads, or plays advertisements. Spyware generally has the same functionality but it is installed without the user's knowledge or consent. Both programs, however, are seen as invasive by consumers and are often deleted through regular use of software designed to find and remove them.

Another method of tracking information for behavioral targeted advertisements is the use of a Hypertext transfer protocol (HTTP) cookie. A cookie is a small file sent by a server and stored on an individual's computer containing information about a specific website. Each time the individual accesses the website the cookie is sent back to the server. Like spyware and adware programs, cookies are seen as invading a consumer's privacy and are easily deleted, either manually or by the use of software.

The deletion of these monitoring devices have implications for advertising and marketing firms that depend on the information for targeting consumer bases, especially advertisement delivery networks that rely on cookies placed by a website other than the one a consumer visits. Even with their use, the data generated pertains to browsing behavior and online purchasing activity. Such data is not analogous to a consumer's global spending habits and, therefore, creates inherent limitations in models identifying advertisements likely to elicit a purchasing response from a given consumer. These cookie based monitoring systems, however, do not take the recent purchases into account but only attempt to cluster users into preexisting categories based upon past browsing behavior.

The typical targeted advertisement system used in interactive media focuses on either the preferences of the entire population using a particular program or the activities of an individual consumer while using the media. Both systems are less then ideal for identifying advertisements with the highest likelihood of eliciting a purchasing response from a particular consumer, basing predictions on models which consider both extraneous and narrow behaviors.

Given the foregoing, a need exists for a method and system for online advertising which effectively targets individual consumers based on their global purchasing behavior.

### SUMMARY

In one implementation, a system for simultaneously providing the content requested by a client as well as client-targeted advertising is presented. The specific advertisements provided are derived using the payment processor history of cashless merchant transactions on a consumer issued account that has also been used in at least one cashless transaction to pay for the content requested. In an alternative implementation, the transactions need not be cashless transactions, because cash or partial cash transactions can reveal additional spending behavior and location data that could be used to target advertisements.

In another implementation, a method is presented for receiving a request for content from a client, where the client has an account issued by an issuer. The method includes fitting the requested content and a targeted advertisement on a page. The targeted advertisement is selected from a database by a derivation using data from multiple cashless transactions conducted on the account with multiple merchants that were submitted for processing to a plurality of acquirers by a payment processor for submission to the issuer for collection. The page with the requested content and targeted advertisement is then served to the client.

Another implementation includes a method for requesting content form a content provider holding an account issued by an issuer. The method comprises, receiving a page addressed from the content provider. The page includes the requested content and an advertisement for a purchase likely to be made on the account. The targeted advertisement is selected from an advertisement database using a derivation based on data from a plurality of cashless transactions on the account with a plurality of merchants that were submitted to a plurality of acquirers for processing by a payment processor for submission to the issuer for collection. Finally, the received page is rendered.

In yet another implementation, a system is presented. The system comprises a broadcaster of content requested for delivery to multiple set top boxes. The top boxes each corresponding to an account issued by an issuer on which a cashless transaction is conducted to pay for the requested content. The requested content is for display on a television set that is in communication with the set top box. The television set has a display area for rendering a page that includes the requested content and an advertisement for a purchase likely to be made on the account. The targeted advertisement is selected from an advertisement database in communication with the head end. The selection itself is made by a computing device in communication with the head end that makes a derivation using data from multiple cashless transactions on the account with multiple merchants that were submitted to a plurality of acquirers for processing by a payment processor for submission to the issuer for collection.

In a still further implementation, a system is presented which comprises a content server serving content that is requested by a client for delivery to the client through an Internet service provider. The client has a corresponding account issued by an issuer on which a cashless transaction is conducted to pay for the content server serving the requested content. The requested content is rendered by a browser application on a display monitor in communication with the client. The display monitor has a display area upon which a page, including the requested content and an advertisement for a purchase likely to be made on the account, is rendered. The targeted advertisement is selected from an advertisement database that is in communication with the content server. The selection is made by an advertisement server, in communication with the content server, using a derivation from a plurality of cashless transactions made on the account with a plurality of merchants that were submitted to a plurality of acquirers for processing by a payment processor for submission to the issuer for collection.

### BRIEF DESCRIPTION OF THE DRAWINGS

Implementations of the invention will become more apparent from the detailed description set forth below when taken in conjunction with the drawings, in which like elements bear like reference numerals.

FIG. 1 depicts a flowchart of an exemplary method of simultaneously delivering content and a targeted advertisements from a content provider to a consumer, where the targeted advertisements are based on the consumer's spending profile;

FIG. 2 depicts a flowchart of an exemplary method for deriving the spending profile of a consumer for identification of a targeted advertisement;

FIG. 3 depicts a flowchart of an exemplary method of selecting and fitting targeted advertisements for simultaneously displaying content and targeted advertisements;

FIG. 4 illustrates an exemplary relationship between the content providers, the advertisers, and the transaction processors in the method depicted in FIG. 1;

FIG. 5 illustrates exemplary methods of simultaneously delivering content and a targeted advertisement to a consumer;

FIG. 6 illustrates an exemplary model for rendering the requested content and targeted advertisement;

FIG. 7 illustrates an exemplary model for displaying the requested content and targeted advertisement on a display;

FIG. 8 illustrates another exemplary model for displaying the requested content and targeted advertisement on a display;

FIG. 9 illustrates an exemplary model for delivering a targeted advertisement to a consumer where the service used by the consumer is static; and

FIG. 10 illustrates an exemplary payment processing network.

### DETAILED DESCRIPTION

Implementations identify an individual consumer presently requesting content from a content provider, where the consumer has been associated with an account. That account then can be used by a transaction processor of a payment processing system to identify the consumer's spending history and derive an accurate spending profile based on the consumer's global spending habits. The spending profile will allow for the real-time selection and delivery to the consumer of an individually targeted advertisement likely to influence the consumer's commercial behavior (an ad that the consumer will likely act upon to make a purchase).

The targeted advertising that is derived by the payment processor, or its agent, is based at least in part on an analysis of the consumer's history of cashless acquired merchant transactions on an issued consumer account. That is, each transaction occurring within a predetermined time period is looked at by the payment processor or its agent, where the transaction was conducted by the consumer with a merchant on an account issued to the consumer by an issuer. The transaction is considered to be a cashless transaction because, rather than making a purchase from the merchant with cash or a check on a written, dated and signed checking account, the consumer made the purchase on the issued consumer account such as by paying the merchant with a credit card, a debit card, or a reloadable pre-paid card. The merchant submits the transaction with the consumer to the merchant's acquirer (i.e., a cashless acquired merchant transaction). The acquirer then submits the transaction to the payment processor who in turn requests the issuer of the consumer's issued account to obtain a payment amount for the purchase. The issuer forwards the payment amount to the payment processor who forwards the payment amount to the acquirer to pay the merchant.

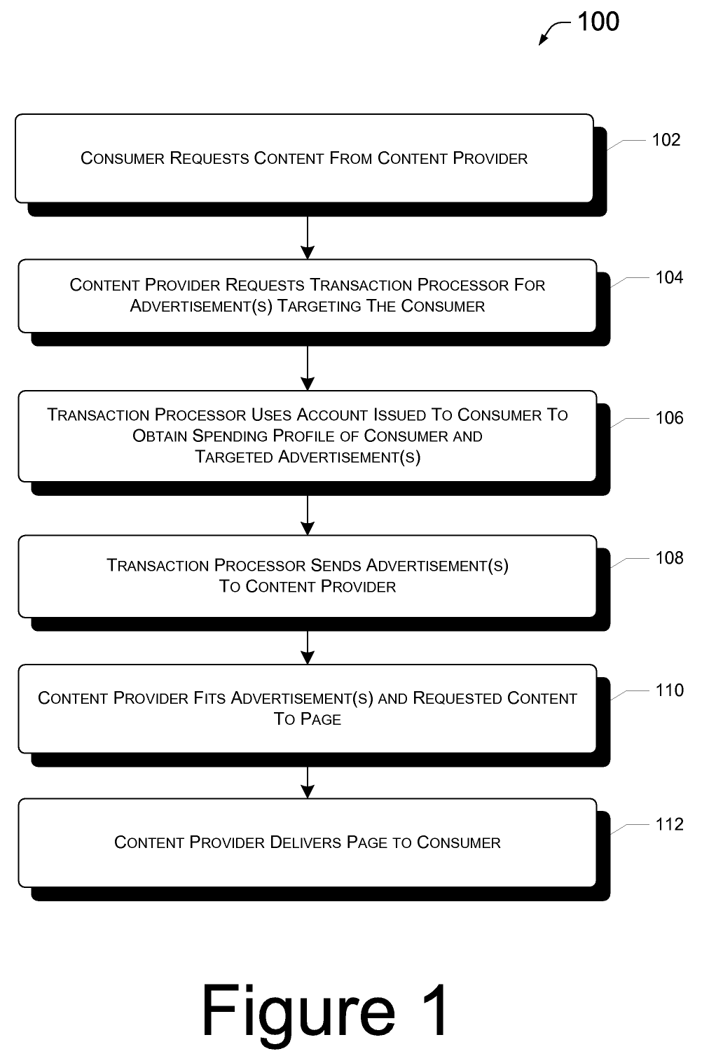

FIG. 1 depicts a flowchart of an exemplary method 100 of simultaneously delivering content and a targeted advertisement from a content provider to a consumer based the consumer's spending profile. In step 102 of method 100, a consumer requests content from a content provider using a client. The client may be, for example, a set top box which receives broadcast television, a browser application executed by a computing device in communication with an Internet service provider or an Internet web service, a cellular telephone in communication with the cellular telephone services, or any other client capable of receiving content from a content provider. The content provider may, by way of example, and not by way of limitation, be an Internet web service provider, such as The Wall Street Journal, or a Internet retailer, such as Amazon. Although the discussion is described in terms of an Internet content provider, it will be evident to a person skilled in the art that the method described is applicable with any form of content provider having the means to identify a consumer with an account number. Other such entities may be, for example, an Internet service provider, provider of a broadcast television service, cellular phone service provider, or any other entity from whom the consumer receives services and can identify the consumer with an account issued by an issuer. As will be discussed further, ideally the consumer has paid for the content provider's services using a cashless transaction, including, but not limited to, payments using a credit card, debit card, or even personal check, and the consumer is associated with the account corresponding to the cashless transaction.

The content provider, in step 104, requests a targeted advertisement from a transaction processor. In the disclosed method, the transaction processor is ideally a payment transaction handler having access to the consumer's spending history on the account from which the consumer made the cashless transaction. An individual skilled in the art will recognize that the transaction processor could be any entity having access to a consumer's spending history, either directly or through a third party.

In one implementation, the consumer is identified to the transaction processor by the consumer's association with a financial account. To identify the associated account, the content provider may, in one implementation, offer a subscription service, associating the consumer with the account used to pay for the subscription. In another implementation, an online retailer may associate the consumer with the account used to purchase an item. In yet another implementation, an Internet service provider may associate the account used to pay for internet service with the consumer. An individual skilled in the art will understand that the consumer will, in most cases, be the account holder of the associated account, but that the consumer may also be another individual. This may occur in situations where, for example, the account holder has shared their subscription information, the service was purchased using an account number belonging to another individual, or the account number is associated with multiple individuals.

In another implementation, the content provider associates the name of the individual having paid for the content provider's service to the consumer requesting content. The transaction processor is queried to determine if the transaction processor has an account associated account holder having the identified name. Upon an affirmative reply, the content provider then requests an advertisement targeted at the consumer from the transaction processor. It will be obvious to a person skilled in the art that the aforementioned implementation is presented by way of example, and not by way of limitation, and that any identifying characteristic known to both the content provider and the transaction processor could be used in the method disclosed.

Once the content provider requests a targeted advertisement, in step 106, the transaction processor obtains the spending profile of the consumer, using an account associated with the consumer, and identifies an advertisement having a high probability of eliciting interest from the consumer and resulting in a purchase being made on the account. In one implementation, the spending profile is determined by the transaction processor. In another implementation, the spending profile is obtained from a third party. For example, if the transaction processor is a distributor of advertisements, the spending profile of a consumer may be supplied by a payment transaction handler, such as a credit card company.

The transaction processor then sends the identified targeted advertisement to the content provider in step 108. In step 110, the content provider fits the targeted advertisement and requested content to a page that is finally delivered to the consumer's client and viewed by the consumer in step 112.

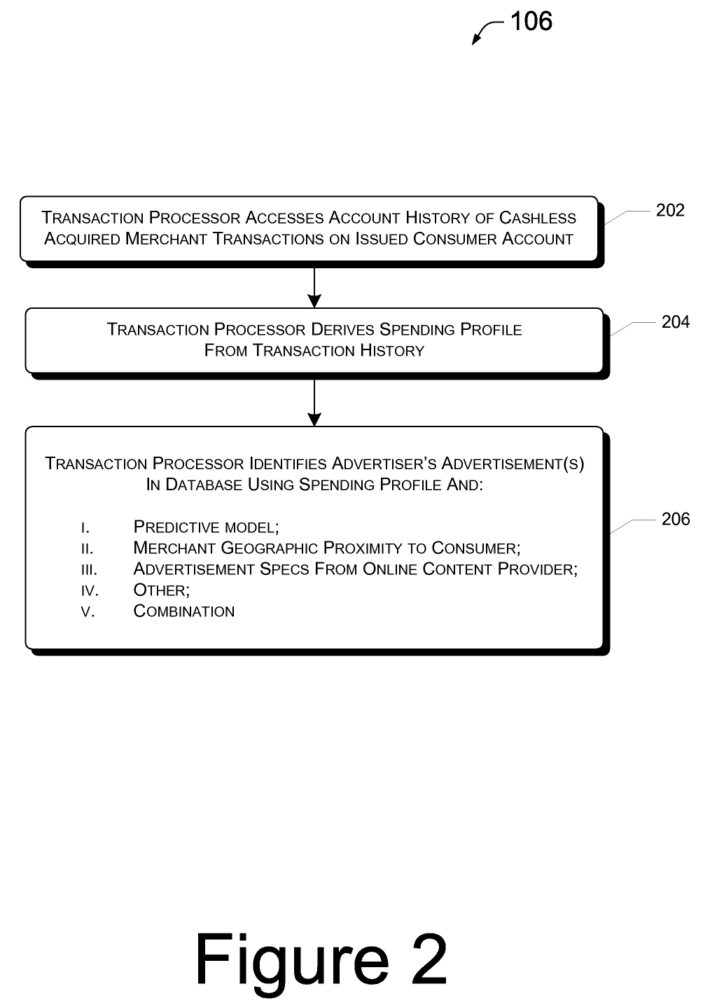

FIG. 2 depicts a flowchart of an exemplary method for obtaining the spending profile of a consumer and identifying a targeted advertisement in step 106 of FIG. 1. In step 202, the transaction processor accesses the account transaction history for the account associated with the consumer. The account transaction history may consist of only cashless acquired merchant transactions, such as may occur in the case of a credit card account, or may have a combined transaction history of both cashless and cash transactions, such as may occur with a debit card.

From the transaction history, the transaction processor derives a spending profile for the consumer in step 204. A spending profile is a model of a consumer's spending habits. Broadly speaking, the models may be stochastic or non-stochastic, discrete or continuous. Such analytics encompass a variety of known techniques from statistics and data mining to determine patterns and/or make predictions about the probability of an event or behavior taking place in the future. For example, in one implementation, the spending profile derived identifies only the percentage of a consumer's total spending in different market segments, using the assumption that an individual is likely to purchase the same or similar items again in the selection of an advertisement. In another implementation, the spending profile is predictive, identifying the probability that the consumer will make a given type of purchase in the future or will make a purchase from a particular merchant or category of merchants. It will be self evident to an individual skilled in the art that techniques for determining spending profiles are readily known and a variety of methods may be used in the described implementation.

The different market segments can also be defined in various manners to suit the interests of the content provider, transaction processor, and advertisers. By way of example, and not by way of limitation, market segments can be defined by categories appealing to specific socioeconomic groups, such as luxury items, by product characteristics, such as entertainment systems or cosmetics, by merchant type, such as hardware vendors or discount department stores.

The specific processes used to derive the spending profile may also be based upon the desired resulting advertisement. By way of example, and not by way of limitation, the derivation may identify an advertisement corresponding to a merchant with whom the consumer has previously engaged in a cashless transaction with or a merchant who has submitted a predetermined number of cashless transactions. In another implementation, the derivation may identify an advertisement corresponding to a merchant having a physical place of business near the consumer and with whom the consumer has previously engaged in a cashless transaction with. In yet another implementation, the derivation may identify an advertisement corresponding to a type of business with which the consumer regularly engages in cashless transactions with.

Finally, in step 206, the transaction processor identifies an advertisement from an advertisement database that is likely to solicit interest from the consumer based on the consumer's spending profile and resulting in a purchase being made on the account. In selecting the advertisement, additional factors may also be considered along with the consumer's spending profile, including, for example, predictions of a consumer's future spending habits, the geographic proximity of merchants to a consumer, specifications supplied by the content provider, specifications supplied by advertisers, any other factor affecting consumer spending, or a combination thereof.

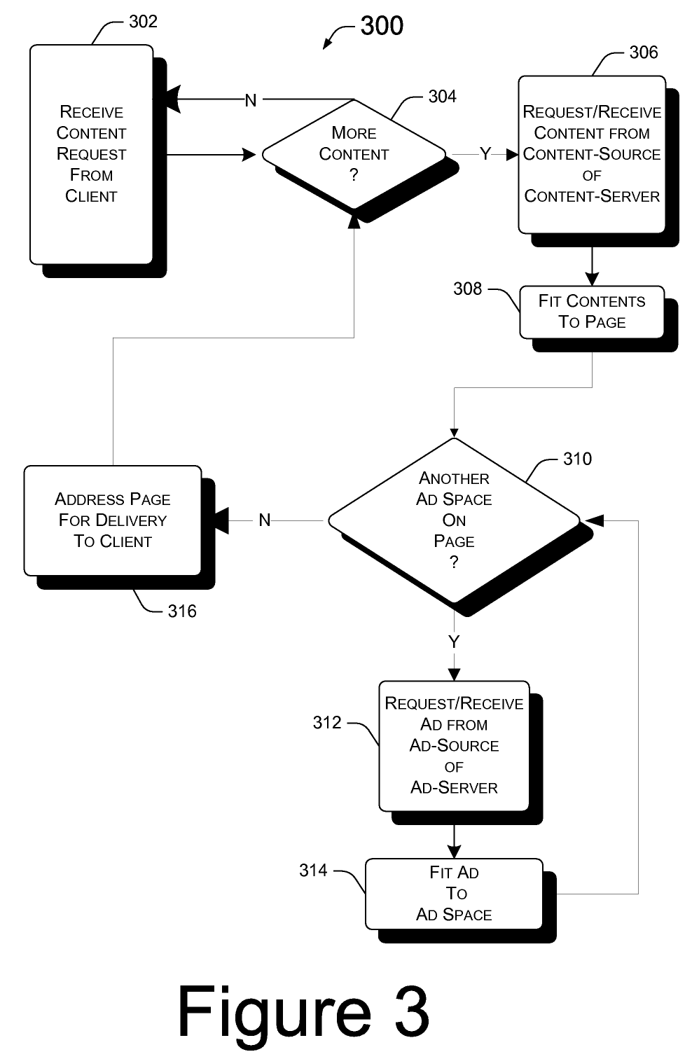

FIG. 3 depicts a flowchart of an exemplary method 300 selecting and fitting targeted advertisements for simultaneous display with content. In step 302, a request from the client for content is received by the content provider. If, in step 304, there exists more content to provide to the client, then, in step 306, a request is made and content is received from the content-source of the content-server. This content is fitted to a page in step 308. In step 310, if there is an advertisement space on the page, then in step 312, a requested is made and a targeted advertisement is received from an advertisement-source of an advertisement-server. In step 314, the received targeted advertisement is fit to the advertisement space on the page. The method 300 then returns to step 310 and a query is made to determine if there is more advertising space on the page. If so, then steps 312 and 314 are repeated. If not, then the page, containing both the content and the targeted advertisements, is addressed for delivery to the client in step 316. Finally, the query made in step 304, to determine if there exists more content for delivery to the client, is repeated. If there is, steps 306 through 316 are repeated. If not, then the page can be delivered to the client. It will be clear to an individual skilled in the art that the above described method is illustrative and not presented as a limitation. The discussed steps may occur in a different order, simultaneously, be omitted, or occur along with additional steps.

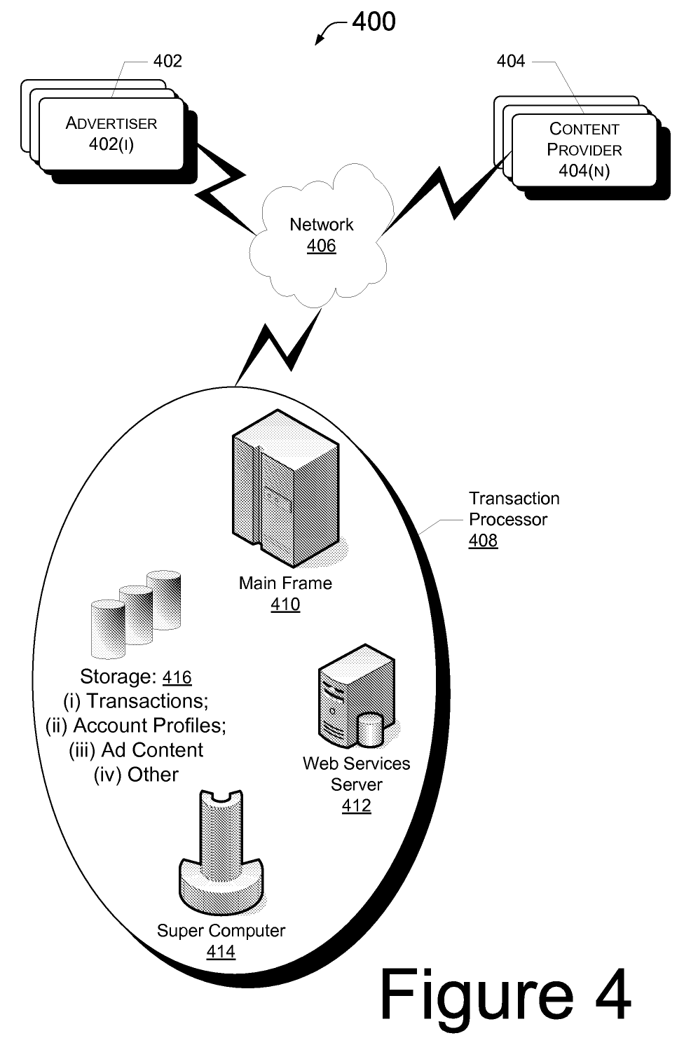

By way of example, and not by way of limitation, FIG. 4 illustrates an exemplary relationship between content providers, advertisers, and a transaction processor with one or more agents thereof. A network 406 connects advertisers 402(1)-(I) and content providers 404(1)-(N) to a transaction processor 408 (or agent thereof). In the illustrated implementation, transaction processor 408 includes a web services server 412, main frame computer 410, super computer 414, and data storage unit 416. The data storage unit 416 may include transaction data (i), account profiles (ii), advertisement content (iii), and any other data (iv) relevant to the disclosed implementation. Advertisements stored on data storage unit 416 are supplied by advertisers 402(1-I) for use by content providers 404 (1-N) in targeted advertising to an account holder.

In one implementation, web services server 412 executes software capable of accepting hypertext transfer protocol (HTTP) requests (or requests in other communication protocols) from web browsers and returns HTTP or like responses with data including requested content and targeted advertisements. In another implementation, web services server 412 is a computer running the aforementioned software. When, for example, content provider 404(n) requests a targeted advertisement for a consumer from transaction processor 408, web services server 412 accepts the request and, after processing by main frame 410 and super computer 414, returns the proper advertisement with content requested by the consumer from content provider 404(n).

Once a spending profile is derived, an identification is made of the type of advertisement that is likely to influence the commercial behavior of the consumer (e.g., an advertisement that targets the consumer with an invitation to make a purchase that the consumer is likely to accept). In one implementation, the desired characteristics are determined using rules, such as, the advertisement must be for within the market segment shown to be that segment in which the consumer's account transaction has the highest spending, where the ad must not be delivered to the consumer more than once in a given time frame. In another implementation, the determination may be based on an algorithm considering multiple variables, for example, a factor weighting market segments having interest to the consumer by the recentness of transactions in those segments. Identification of the type of advertisement may also include, for example, consideration of psychology and/or economic models predicting the consumer's future spending, a merchant's geographic proximity to the consumer, specifications provided by content provider 404(n), specifications of advertiser 402(i), or any combination thereof. Content provider 404(n) may, for example, specify compatibility with a given display (e.g., certain ads are only for cells phone whereas other ads are only for non-mobile clients such as personal computers), that the advertisement be from advertiser 402(i), or the price for advertisement space on a client's display screen. Advertiser 402(i) may specify the type of content providers 404 allowed to receive advertisements, the frequency advertisements can be shown to a given consumer, or the maximum amount advertiser 402(i) is willing to pay for advertisement space.

An advertisement having matching characteristics is then identified from the advertisements stored in data storage unit 416. The identified advertisement is finally sent by web services server 412 to content provider 404(n). In this manner, content provider 404(n) receives a targeted advertisement for real-time delivery to a consumer along with content requested by the consumer from content provider 404(n).

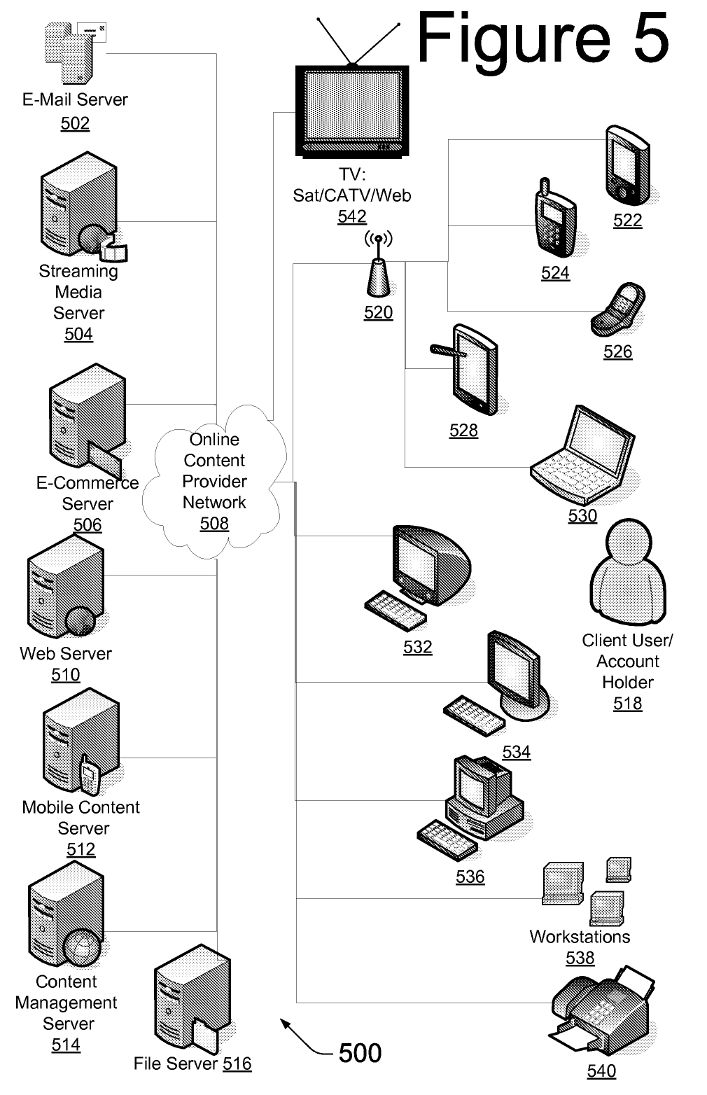

Simultaneous delivery by the content provider of a targeted advertisement, determined using the disclosed method, and the content requested by the consumer may occur using various methods, as illustrated by way of example, and not by way of limitation, in FIG. 5. On the content provider's side, online content provider network 508 is in communication with one or more servers, such as and for example, an email-server 502, a streaming media server 504, an e-commerce server 506, a web services server 510, a mobile content server 512, a content management server 514, a file server 516, or any combination of these as needed to accommodate the device displaying the advertisement and content to consumer 518.

Having received the targeted advertisement from the transaction processor or agent thereof, the server, using online content provider network 508, delivers the targeted advertisement, for example, over a wireless access point 520 to a portable digital assistant (PDA) 522, smart phone 524, cellular telephone 526, tablet computer 528, laptop computer 530, or a combination thereof. In another implementation, the applicable server delivers the targeted advertisement to an iMac® computer 532, all-in-one desktop personal computer (PC) 534, PC 536, one or more workstation(s) 538, fax machine 540, or a combination thereof.

In additional implementations, the targeted advertisement is delivered from a head end (not shown) of a cable or satellite television service provider, where the delivery is made to a television 542 through an integrated or separate set-top box (not shown). In this implementation, content and targeted ads are viewed on television 542 by a user where the content and targeted ads are viewed via satellite television, cable television, internet television, video on demand television, pay-per-view television, or a combination thereof.

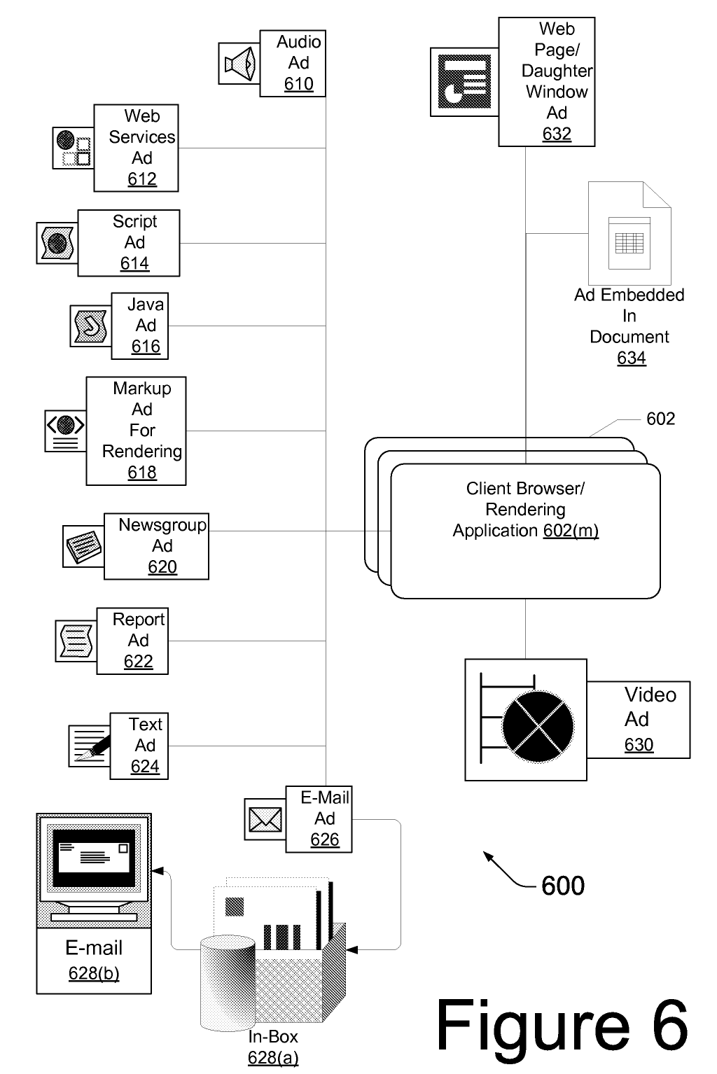

FIG. 6 illustrates an exemplary model for rendering the requested content and targeted advertisement. A client browser/rendering application 602(m), is used to deliver the targeted advertisement in the correct format to a device used by a present consumer of the content provider, each client browser/rendering application 602(1)-(M) having the capability of rendering and delivering the advertisement in particular formats compatible with various devices. The targeted advertisement may be delivered for rendering, by way of example, and not by way of limitation, by an execution of a script or other code. These script or code executions can be in one or more modules, such as an audio advertisement module 610, a web services advertisement module 612, a script advertisement module 614, a java script advertisement module 616, markup advertisement module 618 (e.g., Hypertext Markup Language (HTML), Extensible Markup Language (XML), etc.), a newsgroup advertisement module 620, a report advertisement module 622, a text advertisement module 624, an electronic mail (e-mail) advertisement module 626 to place e-mail ads into an e-mail in-box 606(a) for an e-mail service for delivery as an e-mail 628(b), a video advertisement module 630, or a combination of the foregoing.

If the targeted advertisement is an email advertisement 626, the applicable client browser/rendering application 602(m) will deliver the targeted advertisement to the consumer's inbox 628(a) for display by the consumer's email client 628(b). Other forms of targeted advertisement are, for example, displayed using a webpage or daughter window (632) or embedded in a document (634). If the advertisement is a video advertisement 630, it may be displayed in any medium capable of running video.

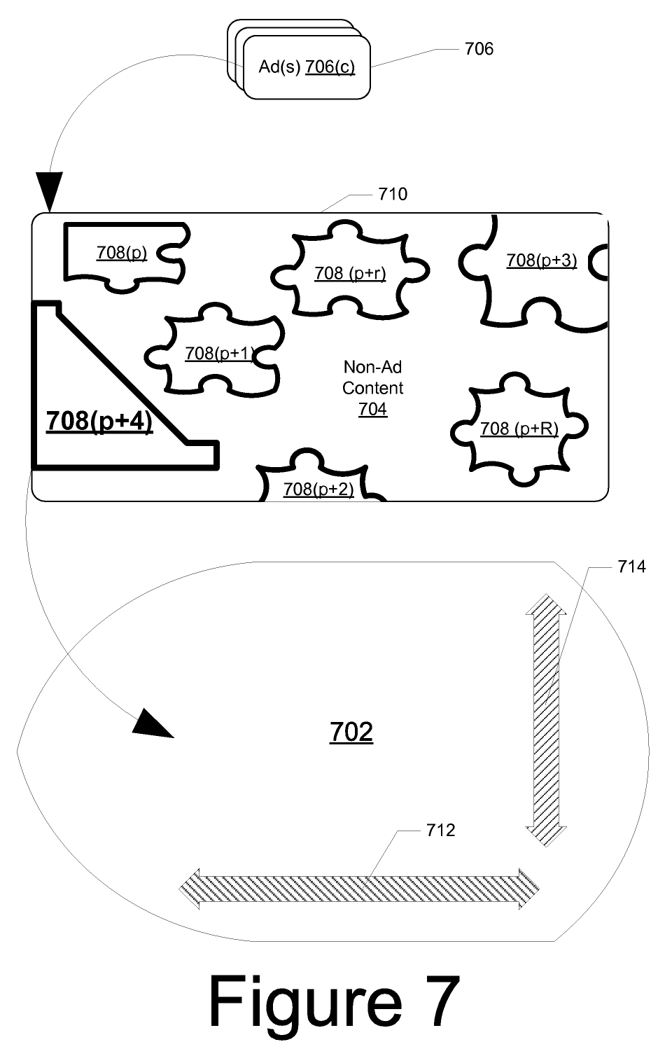

FIG. 7 illustrates an exemplary model for rendering the requested content and targeted advertisement on a display device. A page 710 contains content 704 requested by the consumer as well as advertising spaces 708(p)-(p+R). Advertisements 706(1)-(C) received by the content provider from the transaction processor are fitted in advertising spaces 708(p)-(p+R) on page 710. Once done, page 710 is sent to the consumer for display on display device 702. Through a user making use of a vertical scroll bar 714, horizontal scroll bar 712, or both, the entire contents of page 710 may be viewed by the user when page 710 is larger than the display area of display device 702..

Display device 702 may be any device compatible the service presently used by the consumer. By way of example, and not by way of limitation, a mobile access provider may deliver advertisements for a consumer using their service to a PDA or cellular phone. Alternatively, an internet service provider may deliver advertisements to a computer or smart phone.

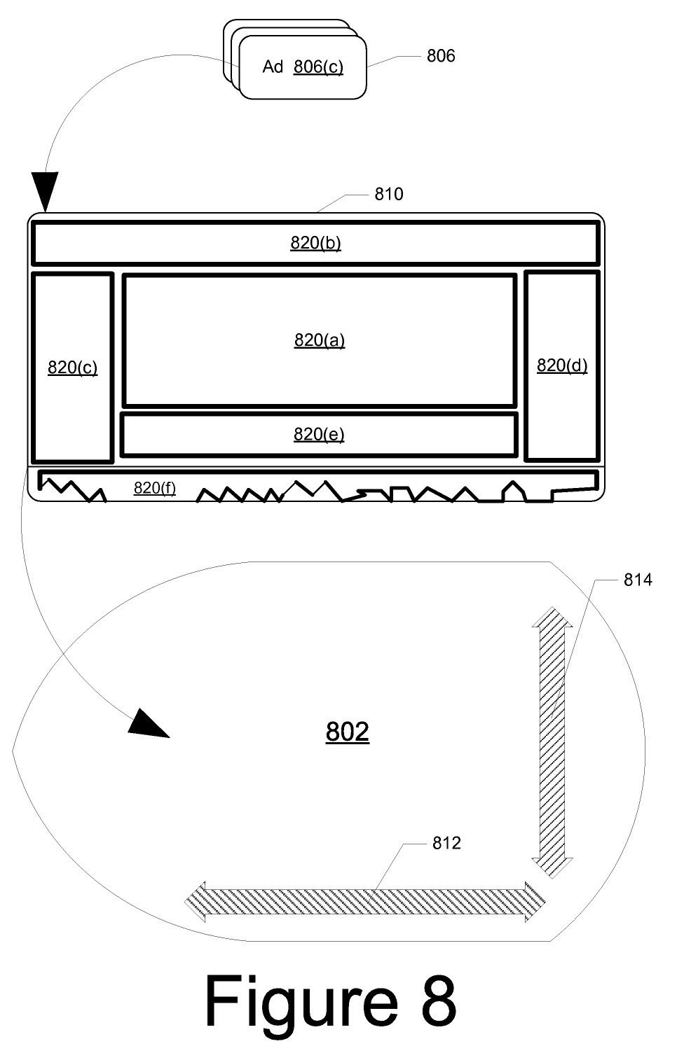

Similar to FIG. 7, FIG. 8 illustrates another exemplary model for rendering the requested content and targeted advertisement on a display device. A page 810 is divided into multiple spaces 820(a)-(f), each capable of displaying content or advertisement. In the present implementation, advertisements 806(1)-(C) are fitted into spaces 820(b)-(f) while the requested content is fitted into space 820(a). Page 810 is then displayed to the consumer on display device 802. Through a user making use of a vertical scroll bar 814, horizontal scroll bar 812, or both, the entire contents of page 810 may be viewed by the user when page 810 is larger than the display area of display device 802.

The exemplary model of FIG. 8 may be used, by way of example, and not by way of limitation, when there are different levels or packages of service that the consumer may purchase. A consumer who selects the highest level or biggest package may receive content in spaces 820(a)-820(e). Advertisements are only displayed in spaces such as 820(f) where they are not visible to the consumer unless the consumer scrolls down to see them using vertical scroll bar 814. Similarly, a consumer who pays for the lowest level or smallest package may receive content only in space 820(a) and will, therefore, see advertisements displayed in spaces 820(b)-(f).

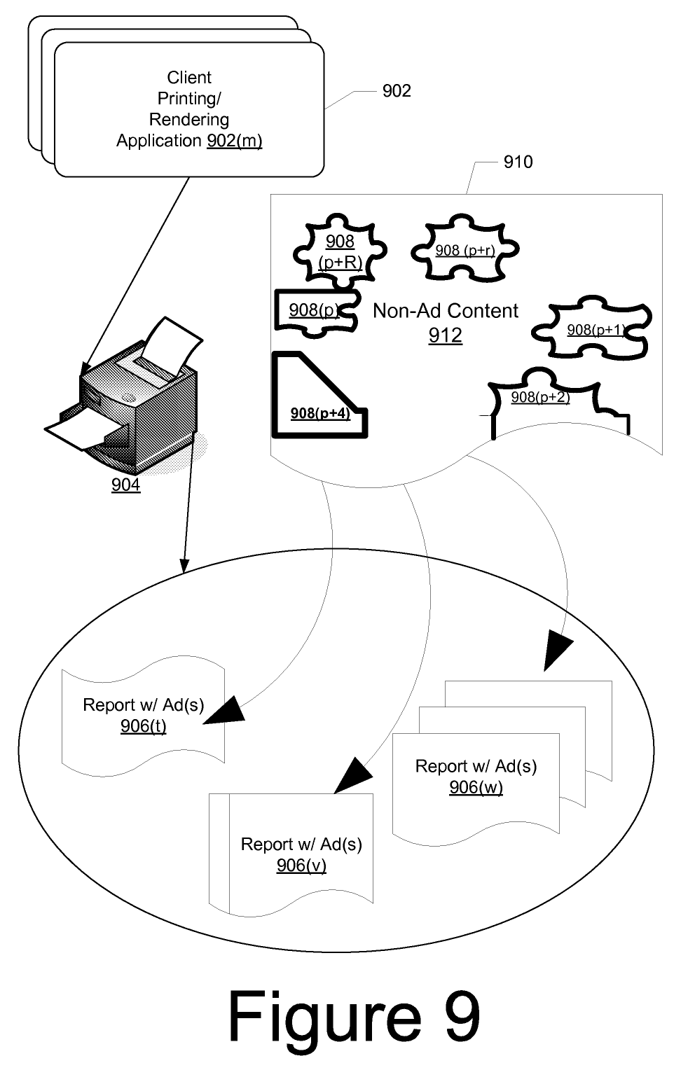

FIG. 9 illustrates an exemplary model for delivering a targeted advertisement to a consumer in a static medium. A client printing/rendering application 902(m) formats the requested content and at least one targeted advertisement for printing to a static medium using a printing device 904, each client printing/rendering application 902(1)-902(M) having the capability of formatting and rendering the content and advertisement for a specific static medium. Printing device 904, may be a laser printer, fax machine, copier, or any other device capable of transferring advertisements 908(1)-908(p+R) and content 912 to a static medium, such as, for example, continuous paper 906(t), lined documents 906(v), or document stacks 906(w). Examples of report with ad(s) 906 include a utility bill, a cable TV bill, an internet service provider bill, a monthly automobile lease or mortgage bill, a monthly credit card bill, etc., where the bill is a statement of a consumer debit to a merchant, where the merchant is typically paid by the consumer with a credit card or the merchant or its agent known the consumer's credit card account number, and where the ads 908 on the report 906 are derived at least in part from an analysis of that consumer's spending on the account of that credit card.

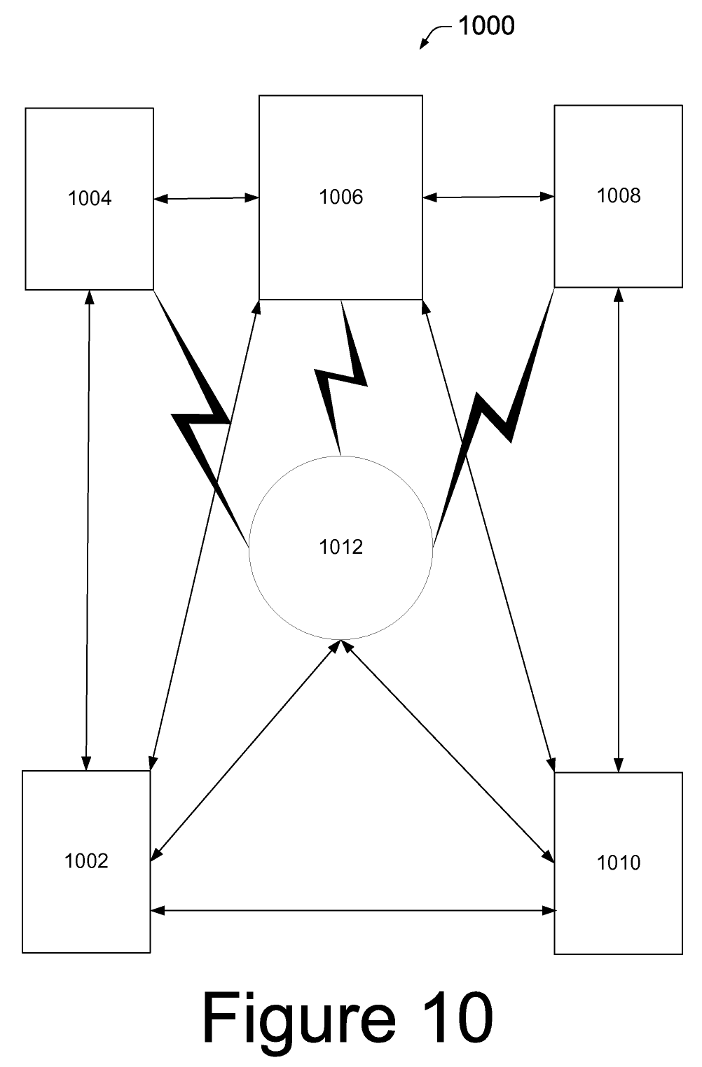

By way of example, and not by way of limitation, the spending profile of the disclosed method can be derived using historical transactions generated by the exemplary payment processing system illustrated in FIG. 10. In general, a transaction includes participation from different entities that are a component of a payment processing system 1000, including an issuer 1002, a transaction handler 1004, such as a credit card company, an acquirer 1006, a merchant 1008, or a user 1010, such as an account holder (e.g.; the consumer associated with the account). The acquirer 1006 and the issuer 1002 can communicate through the transaction handler 1004. The merchant 1008 may be a person or entity that sells goods or services, such as an admission to a future performance event. The merchant 1008 may also be, for instance, a manufacturer, a distributor, a retailer, a load agent, a drugstore, a grocery store, a gas station, a hardware store, a supermarket, a boutique, a restaurant, or a doctor's office. In a business-to-business setting, the user 1010 may be a second merchant making a purchase from another merchant 1008. The merchant 1008 may utilize at least one point-of-sale (POS) terminal that can communicate with the acquirer 1006, the transaction handler 1004, or the issuer 1002. Thus, the POS terminal is in operative communication with the payment processing system 1000.

Typically, a transaction begins with the user 1010, such as an account holder or a consumer, presenting a portable consumer device 1012 to merchant 1008 to initiate an exchange for a good or service. The portable consumer device 1012 may include a payment card, a gift card, a smartcard, a smart media, a payroll card, a health care card, a wrist band, a machine readable medium containing account information, a keychain device such as a SPEEDPASS® device commercially available from ExxonMobil Corporation or a supermarket discount card, a cellular phone, personal digital assistant, a pager, a security card, an access card, a wireless terminal, or a transponder. The portable consumer device 1012 may include a volatile or non-volatile memory to store information such as the account number or an account holder's name.

The merchant 1008 may use the POS terminal to obtain account information, such as an account number, from the portable consumer device 1012. The portable consumer device 1012 may interface with the POS terminal using a mechanism including any suitable electrical, magnetic, or optical interfacing system such as a contactless system using radio frequency or magnetic field recognition system or contact system such as a magnetic stripe reader. The POS terminal sends a transaction authorization request to the issuer 1002 of the portable consumer device 1012. Alternatively, or in combination, the portable consumer device 1012 may communicate with the issuer 1002, the transaction handler 1004, or the acquirer 1006.

The issuer 1002 may authorize the transaction using the transaction handler 1004. The transaction handler 1004 may also clear the transaction. Authorization includes the issuer 1002, or the transaction handler 1004 on behalf of the issuer 1002, authorizing the transaction in connection with the issuer 1002's instructions such as through the use of business rules. The business rules could include instructions or guidelines from the transaction handler 1004, the user 1010, merchant 1008, the acquirer 1006, the issuer 1002, a financial institution, or combinations thereof. The transaction handler 1004 may maintain a log or history of authorized transactions. Once approved, the merchant 1008 will record the authorization, allowing the user 1010 to receive the good or service.

The merchant 1008 may, at discrete periods, such as the end of the day, submit a list of authorized transactions to the acquirer 1006 or other components of the payment processing system 1000. The transaction handler 1004 may compare the submitted authorized transaction list with its own log of authorized transactions. If a match is found, the transaction handler 1004 may route authorization transaction amount requests from the corresponding acquirer 1006 to the corresponding issuer 1002 involved in each transaction. Once the acquirer 1006 receives the payment of the authorized transaction amount from the issuer 1002, it can forward the payment to merchant 1008 less any transaction costs, such as fees. If the transaction involves a debit or pre-paid card, the acquirer 1006 may choose not to wait for the initial payment prior to paying the merchant 1008.

There may be intermittent steps in the foregoing process, some of which may occur simultaneously. For example, the acquirer 1006 can initiate the clearing and settling process, which can result in payment to the acquirer 1006 for the amount of the transaction. The acquirer 1006 may request from the transaction handler 1004 that the transaction be cleared and settled. Clearing includes the exchange of financial information between the issuer 1002 and the acquirer 1006 and settlement includes the exchange of funds. The transaction handler 1004 can provide services in connection with settlement of the transaction. The settlement of a transaction includes depositing an amount of the transaction settlement from a settlement house, such as a settlement bank, which the transaction handler 1004 typically chooses, into a clearinghouse, such as a clearing bank, that the acquirer 1006 typically chooses. The issuer 1002 deposits the same from a clearinghouse, such as a clearing bank, which the issuer 1002 typically chooses, into the settlement house. Thus, a typical transaction involves various entities to request, authorize, and fulfill processing the transaction.

The steps of a method, process, or algorithm described in connection with the implementations disclosed herein may be embodied directly in hardware, in a software module executed by a processor, or in a combination of the two. The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes.

The present invention may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
receiving a request for content from a client corresponding to an account issued by an issuer;
fitting on a page:
the requested content;
and
an advertisement for a purchase likely to be made on the account, the advertisement for the purchase being selected from an advertisement database by a derivation using data from a plurality of cashless transactions with a plurality of merchants that were submitted to a plurality of acquirers for processing by a payment processor for submission to the issuer for collection, each said transaction being conducted on the account;
and
serving the page to the client.

2. The method as defined in claim 1, wherein:
the page is served to the client by a content provider selected from the group consisting of:
a provider of a broadcast television service;
an Internet Service Provider (ISP);
a provider of a cellular telephone service; and
a provider of an Internet Web service;
and
the client is selected from the group consisting of:
a set top box receiving the broadcast television service;
a browser application executing on a computing device that is in communication with the ISP;
a cellular telephone in communication with the cellular telephone services; and
a browser application executing on a computing device that is in communication with the Internet Web service.

3. The method as defined in claim 1, wherein:
the account corresponding to the client is used to pay a payment amount to a content provider for the requested content in one said cashless transaction upon the account;
the content provider submits the one said cashless transaction to one said acquirer for processing by the payment processor who requests the issuer to obtain the payment amount for the one said cashless transaction from the account; and
the issuer forwards the payment amount for the one said cashless transaction to the payment processor who forwards the payment amount for the one said cashless transaction to the one said acquirer to pay the content provider for the one said cashless transaction.

4. The method as defined in claim 1, wherein the requested content and the advertisement for the purchase likely to be made on the account are fitted on the page in a configuration selected from the group consisting of:
the requested content is in a unitary contiguous space adjacent to the advertisement for the purchase likely to be made on the account;
the advertisement for the purchase likely to be made on the account is circumscribed by the requested content; and
the advertisement for the purchase likely to be made on the account is peripheral to the requested content.

5. The method as defined in claim 1, wherein:
the fitting on the page further comprises fitting a plurality of said advertisements on the page, each said advertisement being for a corresponding said purchase that is likely to be made on the account;
and
the page is fitted in a configuration selected from the group consisting of:
the requested content is in a unitary contiguous space with the plurality of said advertisements peripheral to the unitary contiguous space;
the plurality of said advertisements are situated within respective advertisement spaces each being distributed among the requested content;
the plurality of said advertisements are in a unitary contiguous space adjacent to the requested content; and
the requested content is a first unitary contiguous space adjacent to a second unitary contiguous space having therein the plurality of said advertisements.

6. The method as defined in claim 1, wherein the derivation using the data from the plurality of cashless transactions is selected from the group consisting of:
identifying each said advertisement in the advertisement database that corresponds to one said merchant that submitted at least one said cashless transaction;
identifying each said advertisement in the advertisement database that corresponds to one said merchant that submitted a predetermined number of said cashless transactions;
identifying each said advertisement in the advertisement database that corresponds to one said merchant that submitted at least one said cashless transaction and has a physical place of business within a predetermined distance from a physical location of a mailing address corresponding to the account issued by the issuer;
identifying each said advertisement in the advertisement database that corresponds to a category, wherein the category is contained in the data of a predetermined number of said cashless transactions and characterizes a business type of the corresponding said merchant; and
a combination of the foregoing.

7. The method as defined in claim 1, wherein the fitting on the page further comprises:
identifying a form factor from the request for the content from the client, wherein form factor has a final dimension; and
resizing from an initial dimension to a final dimension each of:
the requested content; and
the advertisement for the purchase likely to be made on the account.

8. A method comprising:
requesting content from a content provider holding an account issued by an issuer;
receiving a page addressed from the content provider and including:
the requested content;
and
an advertisement for a purchase likely to be made on the account, the advertisement for the purchase being selected from an advertisement database by a derivation using data from a plurality of cashless transactions with a plurality of merchants that were submitted to a plurality of acquirers for processing by a payment processor for submission to the issuer for collection, each said transaction being conducted on the account;
and
rendering the received page.

9. The method as defined in claim 8, wherein:
the content provider is a server controlled by a service provider selected from the group consisting of:
a provider of a broadcast television service;
an Internet Service Provider (ISP);
a provider of a cellular telephone service; and
a provider of an Internet Web service;
and
the received page is rendered by a client selected from the group consisting of:
a set top box receiving the broadcast television service;
a browser application executing on a computing device that is in communication with the ISP;
a cellular telephone in communication with the cellular telephone services; and
a browser application executing on a computing device that is in communication with the Internet Web service.

10. The method as defined in claim 8, wherein:
the account issued by the issuer is used to pay a payment amount to the content provider to serve the requested content in one said cashless transaction upon the account;
the content provider submits the one said cashless transaction to one said acquirer for processing by the payment processor who requests the issuer to obtain the payment amount for the one said cashless transaction from the account; and
the issuer forwards the payment amount for the one said cashless transaction to the payment processor who forwards the payment amount for the one said cashless transaction to the one said acquirer to pay the content provider for the one said cashless transaction.

11. The method as defined in claim 8, wherein the received page has a configuration selected from the group consisting of:
the requested content is in a unitary contiguous space adjacent to the advertisement for the purchase likely to be made on the account;
the advertisement for the purchase likely to be made on the account is circumscribed by the requested content; and
the advertisement for the purchase likely to be made on the account is peripheral to the requested content.

12. The method as defined in claim 8, wherein:
the received page further comprises a plurality of said advertisements each being for a corresponding said purchase that is likely to be made on the account;
and
the received page is formatted in a configuration selected from the group consisting of:
the requested content is in a unitary contiguous space with the plurality of said advertisements peripheral to the unitary contiguous space;
the plurality of said advertisements are situated within respective ad spaces each being distributed among the requested content;
the plurality of said advertisements are in a unitary contiguous space adjacent to the requested content; and
the requested content is a first unitary contiguous space adjacent to a second unitary contiguous space having therein the plurality of said advertisements.

13. The method as defined in claim 8, wherein the derivation using the data from the plurality of cashless transactions is selected from the group consisting of:
identifying each said advertisement in the advertisement database that corresponds to one said merchant that submitted at least one said cashless transaction;
identifying each said advertisement in the advertisement database that corresponds to one said merchant that submitted a predetermined number of said cashless transactions;
identifying each said advertisement in the advertisement database that corresponds to one said merchant that submitted at least one said cashless transaction and has a physical place of business within a predetermined distance from a physical location of a mailing address corresponding to the account issued by the issuer;
identifying each said advertisement in the advertisement database that corresponds to a category, wherein the category is contained in the data of a predetermined number of said cashless transactions and characterizes a business type of the corresponding said merchant; and
a combination of the foregoing.

14. The method as defined in claim 8, wherein the page is rendered on a renderer selected from the group consisting of:
a storage device to store the rendered page;
a display device;
a display terminal having:
a display area that is smaller the page to be rendered; and
a user interface with a user operable scroll utility for viewing on the display area a portion of the page;
a printer to render on paper a hard copy of the page; and
a printer to render on a plurality of paper leaves a hard copy of the page.

15. A system comprising a broadcaster of requested content for delivery to a plurality of set top boxes each corresponding to an account issued by an issuer on which a cashless transaction is conducted to pay for the requested content, the requested content being for display upon a television set in communication with the set top box, the television set having a display area upon which a page is rendered, the page including the requested content and an advertisement for a purchase likely to be made on the account, the advertisement for the purchase being selected from an advertisement database in communication with the head end, the selection being made by a computing device in communication with the head end, the computing device making a derivation using data from a plurality of cashless transactions with a plurality of merchants that were submitted to a plurality of acquirers for processing by a payment processor for submission to the issuer for collection, each said transaction being conducted on the account.

16. The system as defined in claim 15, wherein the requested content and the advertisement for the purchase likely to be made on the account are fitted on the page in a configuration selected from the group consisting of:
the requested content is in a unitary contiguous space adjacent to the advertisement for the purchase likely to be made on the account;
the advertisement for the purchase likely to be made on the account is circumscribed by the requested content; and
the advertisement for the purchase likely to be made on the account is peripheral to the requested content.

17. The system as defined in claim 15, further comprising means for fitting on the page the requested content and a plurality of said advertisements each being one said advertisement for a corresponding said purchase that is likely to be made on the account, wherein the page is fitted in a configuration selected from the group consisting of:
the requested content is in a unitary contiguous space with the plurality of said advertisements peripheral to the unitary contiguous space;
the plurality of said advertisements are situated within respective ad spaces each being distributed among the requested content;
the plurality of said advertisements are in a unitary contiguous space adjacent to the requested content; and
the requested content is a first unitary contiguous space adjacent to a second unitary contiguous space having therein the plurality of said advertisements.

18. The system as defined in claim 15, wherein the derivation using the data from the plurality of cashless transactions is selected from the group consisting of:
identifying each said advertisement in the advertisement database that corresponds to one said merchant that submitted at least one said cashless transaction;
identifying each said advertisement in the advertisement database that corresponds to one said merchant that submitted a predetermined number of said cashless transactions;
identifying each said advertisement in the advertisement database that corresponds to one said merchant that submitted at least one said cashless transaction and has a physical place of business within a predetermined distance from a physical location of a mailing address corresponding to the account issued by the issuer;
identifying each said advertisement in the advertisement database that corresponds to a category, wherein the category is contained in the data of a predetermined number of said cashless transactions and characterizes a business type of the corresponding said merchant; and
a combination of the foregoing.

19. The system as defined in claim 15, wherein the requested content and the advertisement for the purchase likely to be made on the account are fitted on the page by:
identifying a form factor from the request for the content from the client, wherein form factor has a final dimension; and
resizing from an initial dimension to a final dimension each of:
the requested content; and
the advertisement for the purchase likely to be made on the account.

20. A system comprising a content server serving content requested by a client for delivery to the client through an Internet service provider, the client having a corresponding account issued by an issuer on which a cashless transaction is conducted to pay for the content server serving the requested content to the client, the requested content being rendered by a browser application executed by the client, the rendering being upon a display monitor in communication with the client, the display monitor having a display area upon which a page is rendered, the page including the requested content and an advertisement for a purchase likely to be made on the account, the advertisement for the purchase being selected from an advertisement database in communication with the content server, the selection being made by an ad server in communication with the content server, the ad server making a derivation using data from a plurality of cashless transactions with a plurality of merchants that were submitted to a plurality of acquirers for processing by a payment processor for submission to the issuer for collection, each said transaction being conducted on the account.

21. The system as defined in claim 20, wherein the requested content and the advertisement for the purchase likely to be made on the account are fitted by the content server on the page in a configuration selected from the group consisting of:
the requested content is in a unitary contiguous space adjacent to the advertisement for the purchase likely to be made on the account;
the advertisement for the purchase likely to be made on the account is circumscribed by the requested content; and
the advertisement for the purchase likely to be made on the account is peripheral to the requested content.

22. The system as defined in claim 20, further comprising means for fitting on the page both the requested content and a plurality of said advertisements each being one said advertisement for a corresponding said purchase that is likely to be made on the account, wherein the page is fitted in a configuration selected from the group consisting of:
the requested content is in a unitary contiguous space with the plurality of said advertisements peripheral to the unitary contiguous space;
the plurality of said advertisements are situated within respective ad spaces each being distributed among the requested content;
the plurality of said advertisements are in a unitary contiguous space adjacent to the requested content; and
the requested content is a first unitary contiguous space adjacent to a second unitary contiguous space having therein the plurality of said advertisements.

23. The system as defined in claim 20, wherein the derivation using the data from the plurality of cashless transactions is selected from the group consisting of:
identifying each said advertisement in the advertisement database that corresponds to one said merchant that submitted at least one said cashless transaction;
identifying each said advertisement in the advertisement database that corresponds to one said merchant that submitted a predetermined number of said cashless transactions;
identifying each said advertisement in the advertisement database that corresponds to one said merchant that submitted at least one said cashless transaction and has a physical place of business within a predetermined distance from a physical location of a mailing address corresponding to the account issued by the issuer;
identifying each said advertisement in the advertisement database that corresponds to a category, wherein the category is contained in the data of a predetermined number of said cashless transactions and characterizes a business type of the corresponding said merchant; and
a combination of the foregoing.

24. The system as defined in claim 20, wherein the requested content and the advertisement for the purchase likely to be made on the account are fitted on the page by:
identifying a form factor from the request for the content from the client, wherein form factor has a final dimension; and
resizing from an initial dimension to a final dimension each of:
the requested content; and
the advertisement for the purchase likely to be made on the account.

25. The system as defined in claim 20, wherein the advertisement for the purchase likely to be made on the account is rendered on the page in a multimedia format selected from the group consisting of a static image, a motion video image, a static image with an audio component; and motion video image with an audio component.

26. Any system of providing to a client content requested by the client while simultaneously providing to the client targeted advertising derived from a payment processor history of cashless acquired merchant transactions on a consumer issued account also used in at least one said cashless transaction to pay for the content requested by the client.

27. The system as defined in claim 26, wherein:
the provider of the content requested by the client is selected from the group consisting of:
a provider of a broadcast television service;
an Internet Service Provider (ISP);
a provider of a cellular telephone service; and
a provider of an Internet Web service;
and
the client is selected from the group consisting of:
a set top box receiving the broadcast television service;
a browser application executing on a computing device that is in communication with the ISP;
a cellular telephone in communication with the cellular telephone services; and
a browser application executing on a computing device that is in communication with the Internet Web service.

28. The system as defined in claim 26, wherein:
the at least one said cashless acquired merchant transaction to pay for the content requested by the client is submitted to an acquirer for processing by a payment processor who requests an issuer of the consumer issued account to obtain a payment amount for the at least one said cashless acquired merchant transaction to pay a party for providing the requested content to the client; and
the issuer forwards the payment amount to the payment processor who forwards the payment amount to the acquirer to pay the party for providing the requested content to the client.
